(19) United States
(12) Patent Application Publication
(10) Pub. No.: US 2012/0082922 A1
(43) Pub. Date: Apr. 5, 2012

(54) COMPOSITE ELECTRODE MATERIAL AND METHOD OF PRODUCING THE SAME, NEGATIVE ELECTRODE FOR METAL-AIR BATTERY, AND METAL-AIR BATTERY

(75) Inventors: Jun-ichi YAMAKI, Fukuoka-shi (JP); Akisuke ITO, Fukuoka-shi (JP); Shigeto OKADA, Fukuoka-shi (JP); Taketsugu YAMAMOTO, Tsukuba-shi (JP)

(73) Assignees: KYUSHU UNIVERSITY, NATIONAL UNIVERSITY CORPORATION, Fukuoka-shi (JP); SUMITOMO CHEMICAL COMPANY, LIMITED, Tokyo (JP)

(21) Appl. No.: 13/249,612

(22) Filed: Sep. 30, 2011

(30) Foreign Application Priority Data
Oct. 1, 2010 (JP) P2010-224134

(51) Int. Cl. H01M 4/96; H01M 8/00

(52) U.S. Cl. 429/532; 429/535

(57) ABSTRACT

The present invention relates to a composite electrode material having a carbon base material and iron oxide particles mainly containing Fe₃O₄ and being supported on the carbon base material and the particles have a D₉₀ of 50 nm or less. In the composite electrode material, since the particle size of the iron oxide particles mainly containing Fe₃O₄ serving as an active material is small, the electron conductivity of the composite electrode material is not considerably reduced even when being covered with a Fe(OH)₂ layer as a reactive intermediate for an electrode reaction. Thus, when the composite electrode material is used, an iron negative electrode having sufficient electron conductivity and charge-discharge cycle characteristics is provided. A negative electrode including the composite electrode material is favorably used as a negative electrode for a metal-air battery.

### BACKGROUND OF THE INVENTION

1. Field of the Invention

The present invention relates to a composite electrode material using iron oxides as an electrode active material and a method of producing the same, a negative electrode for a metal-air battery containing the composite electrode material, and the metal-air battery.

2. Related Background Art

A metal-air battery using oxygen in air as an active material can achieve a high energy density and thus is expected to be applied to various uses for an electrical vehicle and the like.

Various metals are being considered as a negative electrode active material. An iron-air battery using iron oxide as a negative electrode active material has a theoretical capacity of 1280 mAh/g, which is considerably large as compared to a lithium-ion battery (theoretical capacity: 158 mAh/g). Further, the iron oxide as the negative electrode active material is provided at low cost. Thus, the iron-air battery is especially expected to be applied to various uses.

As a negative electrode for a secondary battery, an iron negative electrode (here, the iron negative electrode means a negative electrode having iron or iron oxide as a negative active material) can be charged without decomposition reaction of an electrolytic solution by using an alkaline solution of high concentration on theoretical grounds. Further, the iron negative electrode has advantages that dendrite crystals are not easily formed as compared to conventional zinc and a charge-discharge cycle life is relatively long.

The reactions of the iron negative electrode in the alkaline solution are shown in the following equations.

Fe+2OH⁻═Fe(OH)₂+2e⁻E⁰=−0.975 V vs. Hg/HgO (1)

Fe(OH)₂+OH⁻=FeOOH/H₂O+e⁻E⁰=−0.658 V vs. Hg/HgO (2)

and/or

3Fe(OH)₂+2OH⁻=Fe₃O₄/4H₂O+2e⁻E⁰=−0.658 V vs. Hg/HgO (3)

On the other hand, Fe(OH)₂ generated as a reactive intermediate for the electrode reaction of the iron negative electrode has a low electronic conductivity and covers a surface of iron oxide (Fe₂O₃ or Fe₃O₄) serving as an active material. Accordingly, Fe internally existing away from the surface remains unreacted without being used for the reaction. Consequently, with an increase of a charge-discharge cycle number, overvoltage may be increased and reversibility of the electrode reaction may be decreased.

To solve such problems, a method of minimizing a diameter of iron oxide particulates serving as an active material is suggested. Since an Fe(OH)₂ layer formed on a surface becomes relatively thin when the diameter of the iron oxide particulates serving as the active material is reduced, a resistance derived from the Fe(OH)₂ layer formed on the surface is reduced and an apparent electron conductivity is improved. Further, internal iron oxide can contribute to the reaction. Thus, the reversibility of the electrode reaction is enhanced.

For example, Non-Patent Document 1 (B. T. Hang et al., Journal of Power Sources, 150 (2005)261-271) discloses a negative electrode for a metal-air battery containing a composite electrode material supporting iron oxide (Fe₂O₃) particulates on a carbon base material such as acetylene black. When the negative electrode containing the composite electrode material is used, a reactive surface area is increased by microparticulation of the iron oxide (Fe₂O₃) serving as an active material and electron transfer paths are increased by compounding with the carbon base material. Thus, the apparent electronic conductivity as a whole electrode and the initial characteristics of a charge-discharge cycle are improved.

### SUMMARY OF THE INVENTION

The composite electrode material disclosed in Non-Patent Document 1 is produced by immersing the carbon base material in a solution containing iron nitrate as an iron precursor, drying it, and calcining it. In the drying and calcining step, iron oxide on the carbon base material is agglomerated and therefore relatively large particles (more than 50 nm) are easily generated. Consequently, the number of unreacted iron oxide components is increased. Thus, with the increase of the charge-discharge cycle number, a discharge capacity tends to be reduced.

Further, a bonding force between the iron oxide serving as the active material and the carbon base material such as acetylene black acting as a conductive path is weak. Accordingly, the iron oxide particulates may be desorbed from the carbon base material.

Thus, the composite electrode material supporting the iron oxide on the carbon base material used for the negative electrode for the metal-air battery still has room for improvement.

In view of such circumstances, an object of the present invention is to provide a composite electrode material having superior electrode characteristics and a method of making the same. Another object of the present invention is to provide a negative electrode containing the composite electrode material and the metal-air battery.

As a result of extensive investigations for solving the above-described problems, the inventors have found that iron oxide particulates can be supported to be highly dispersed on a carbon base material by bringing an organic solution containing an iron complex compound into contact with the carbon base material to complete the present invention.

The present invention is directed to the followings.

(1) A composite electrode material comprising a carbon base material and iron oxide particles mainly containing Fe₃O₄ and being supported on the carbon base material, in which the iron particles have a D₉₀ of 50 nm or less.

(2) The composite electrode material described in (1), in which the composite electrode material has an Fe/C mass ratio of from 1/0.01 to 1/100.

(3) The composite electrode material described in (1) or (2), in which the carbon base material is fibrous carbon.

(4) The composite electrode material described in (3), in which the fibrous carbon has a hollow structure.

(5) A negative electrode for a metal-air battery, the negative electrode containing the composite electrode material described in any one of (1) to (4).

(6) A metal-air battery containing the negative electrode for the metal-air battery described in (5), a positive electrode, and an electrolytic solution.

(7) The metal-air battery described in (6), in which the electrolytic solution contains a hydrogen generation inhibitor.

(8) A method for producing a composite electrode material, comprising the steps of: bringing a carbon base material into contact with an organic solution containing an iron complex compound at a temperature of 100 to 400° C. under non-oxidizing atmosphere, thereby forming a liquid substance containing iron oxide particles mainly containing Fe₃O₄; and separating the liquid substance into a solid phase and a liquid phase and drying the solid phase to obtain a dried solid.

(9) The method of producing the composite electrode material described in (8) further comprising a step of subjecting the dried solid to thermal treatment at a temperature of 300 to 1000° C. under non-oxidizing atmosphere.

(10) The method of producing the composite electrode material described in (8) or (9), in which the organic solution has a mass ratio of the iron complex compound to the carbon base material of from 1/0.01 to 1/10.

(11) The method of producing the composite electrode material described in any one of (8) to (10), in which the iron complex compound is tris(2,4-pentadionato)iron(III).

(12) The method of producing the composite electrode material described in any one of (8) to (11), in which the concentration of the iron complex compound in the organic solution is 0.01 to 1 mol/L.

(13) The method of producing the composite electrode material described in any one of (8) to (11), in which the concentration of the iron complex compound in the organic solution is 0.1 to 0.2 mol/L.

(14) The method of producing the composite electrode material described in any one of (8) to (13), in which the organic solution contains a surfactant.

(15) The method of producing the composite electrode material described in (14), in which the surfactant is oleic acid.

(16) The method of producing the composite electrode material described in any one of (8) to (15), in which the carbon base material is fibrous carbon.

(17) The method of producing the composite electrode material described in (16), in which the fibrous carbon has a hollow structure.

Since the particle size of the iron oxide particles mainly containing Fe₃O₄ serving as an active material is small, the electron conductivity of the composite electrode material according to the invention is not considerably reduced even when being covered with an Fe(OH)₂ layer as a reactive intermediate for an electrode reaction. Thus, when the composite electrode material is used, a negative electrode having superior electrode characteristics can be provided. The negative electrode including the composite electrode material is favorably used as a negative electrode for a metal-air battery.

### BRIEF DESCRIPTION OF THE DRAWINGS

FIG. 1 shows XRD patterns of composite electrode materials 1 to 3;

FIG. 2 shows a TEM image of the composite electrode material 1;

FIG. 3 shows a TEM image of the composite electrode material 2;

FIG. 4 shows a TEM image of the composite electrode material 3;

FIG. 5 shows XRD patterns of composite electrode materials 4 to 6;

FIG. 6 shows a TEM image of the composite electrode material 4;

FIG. 7 shows a TEM image of the composite electrode material 5;

FIG. 8 shows a TEM image of the composite electrode material 6;

FIG. 9 shows XRD patterns of composite electrode materials 7 and 8;

FIG. 10 shows a TEM image of the composite electrode material 7;

FIG. 11 shows a TEM image of the composite electrode material 8;

FIG. 12 shows results of a charge-discharge test (in which K₂S is not added) using an electrode of the composite electrode material 4;

FIG. 13 shows results of a charge-discharge test (in which K₂S is added) using the electrode of the composite electrode material 4;

FIG. 14 shows cycle characteristics of a charge-discharge test (in which K₂S is added) using the electrode of the composite electrode material 4;

FIG. 15 shows cycle characteristics of a charge-discharge test (in which K₂S is added) using an electrode of the composite electrode material 5;

FIG. 16 shows cycle characteristics of a charge-discharge test (in which K₂S is added) using an electrode of the composite electrode material 6;

FIG. 17 shows cycle characteristics of a charge-discharge test (in which K₂S is added) using an electrode of the composite electrode material 7; and

FIG. 18 shows cycle characteristics of a charge-discharge test (in which K₂S is added) using an electrode of the composite electrode material 8.

### DESCRIPTION OF THE PREFERRED EMBODIMENTS

The present invention relates to a composite electrode material comprising a carbon base material and iron oxide particles mainly containing Fe₃O₄ and being supported on the carbon base material and the iron oxide particles has a D₉₀ of 50 nm or less. The composite electrode material is a composite material and also an electrode material.

In the composite electrode material according to this embodiment, the iron oxide particles mainly containing Fe₃O₄ (hereinafter sometimes referred to as “Fe₃O₄ particulates”) are composed mostly of Fe₃O₄ having higher reaction activity than other iron oxides (Fe₂O₃ and the like). In this embodiment, the “iron oxide mainly containing Fe₃O₄” means that 60 mol % or more (preferably 90 mol % or more) of the iron oxide is Fe₃O₄. Incidentally, the type of the iron oxide can be identified by an X-ray diffraction method.

With respect to a particle size of the Fe₃O₄ particulates, the D₉₀ is necessary to be 50 nm or less. When the D₉₀ exceeds 50 nm, the electron conductivity is not sufficient in a case where the Fe₃O₄ particulates are covered with an Fe(OH)₂ layer. Accordingly, the electrode performance is remarkably reduced. As the particle size of the Fe₃O₄ particulates is reduced, the Fe₃O₄ particulates are hetero-bonded to a carbon base material more easily. Therefore, the D₉₀ is preferably 30 nm or less, more preferably 10 nm or less.

The D₉₀ represents a particle size when an accumulated amount in an accumulated distribution of particles is 90%. More specifically, the D₉₀ is a value obtained from each particle size (diameter) measured by randomly extracting 100 particles.

Further, the Fe₃O₄ particulates in this embodiment preferably have a D₁₀₀ of 50 nm or less, more preferably 30 nm or less, and still more preferably 10 nm or less, as similar to the above. The “Fe₃O₄ particulates have a D₁₀₀ of 50 nm or less” means that all the Fe₃O₄ particulates have a particle size (diameter) of 50 nm or less.

When the particle size of the Fe₃O₄ particulates is small, an effective surface area where an electrochemical reaction proceeds is increased. Accordingly, the Fe₃O₄ particulates tend to have a higher electrode reaction activity. However, when the particle size is too small, the density of an active material is reduced and thus the energy density as a battery may be reduced. Therefore, the particle size is preferably 1 nm or more, more preferably 2 nm or more.

The shape of the Fe₃O₄ particulates is not particularly limited as long as it is granular. When the shape of the Fe₃O₄ particulates is not spherical, a length in a direction consistent with the maximum length in a particle is a particle size.

In the composite electrode material according to this embodiment, a carbon base material is a material mainly containing carbon atoms. The carbon base material may contain elements other than carbon or impurities of 2 mass % or less, or 3 mass % or less, for improving its performance. The carbon base material can support the Fe₃O₄ particulates on its surface. When the composite electrode material according to this embodiment is used as an electrode, the carbon base material has a function as a conductive path.

As the carbon base material, flake-shaped carbon such as graphite, ultrafine carbon such as acetylene black (AB), or fibrous carbon such as carbon nanotube and carbon nanofiber may be used in any form. Among these, the fibrous carbon, which has a high conductivity and a favorable contact property, is preferable.

The length and diameter of the fibrous carbon are not particularly limited, and can be appropriately decided. Fibrous carbon which is favorable for both of supporting the Fe₃O₄ particulates to be highly dispersed as carriers and having the electrical conductivity when a negative electrode for an air battery is produced, has a total length of 0.1 to 500 μm, preferably 1 to 200 μm, has a diameter of 2 to 1,000 nm, preferably 10 to 200 nm, and has an aspect ratio of 5 to 100,000, preferably 10 to 20,000.

Both of fibrous carbon having a hollow structure and fibrous carbon not having the hollow structure can be used. The fibrous carbon having the hollow structure is preferable. When the fibrous carbon having the hollow structure is used, the fibrous carbon can support the Fe₃O₄ particulates even on its inner surface and therefore a capacity per unit volume tends to be improved. Also, when the fibrous carbon having the hollow structure is used, a large discharge capacity tends to be obtained early in charge-discharge cycles.

A method of producing the fibrous carbon is not particularly limited. An arc discharge method, chemical vapor deposition (CVD) method, or a catalytic-supported chemical vapor deposition method may be used. The catalytic-supported chemical vapor deposition method, which is one of the favorable methods of producing the fibrous carbon, will be described below in detail.

In the catalytic-supported chemical vapor deposition method, fibrous carbon is generated by bringing gas as a carbon source into contact with a carrier supporting a catalyst metal having a catalyst action for formation of carbon at the temperature of 450° C. or more.

The gas as the carbon source is not particularly limited as long as it contains carbon. Carbon hydride such as methane, ethane, propane, butane, ethylene, propene, and butene, or mixed gas of such carbon hydride and hydrogen or inactive gas (such as nitrogen and argon) may be favorably used.

As the catalyst metal, a metal comprising transition metal elements such as Co, Fe, Ni, Mo, W, Mn, Ti, V, Cr, Nb, its alloy, or its metal compound (for example, metal oxide, metal boride, chloride, nitrate) may be used.

It is required that the carrier be stable when the catalytic-supported chemical vapor deposition method is performed. Examples of the carrier include an inorganic oxide such as alumina and silica, and a carbon material such as carbon black. Incidentally, the carrier supporting the catalyst metal may be granulated by a polymer resin binder.

The fibrous carbon may be subjected to graphitization treatment. For example, the graphitization treatment of the fibrous carbon can be conducted at the temperature of 2500° C. or more in an inactive gas atmosphere such as Ar.

In the composite electrode material according to this embodiment, a supporting amount of the Fe₃O₄ particulates is represented as a mass ratio Fe/C of iron (Fe) to carbon (C), which are constituent elements of the composite electrode material. The composite electrode material usually has an Fe/C mass ratio of from 1/0.01 to 1/100, preferably from 1/0.02 to 1/50, and more preferably from 1/0.05 to 1/30. In other words, the range of the Fe/C is usually 1/100≦Fe/C≦1/0.01, preferably 1/50≦Fe/C≦1/0.02, and more preferably 1/30≦Fe/C≦1/0.05.

When the supporting amount of the Fe₃O₄ particulates is within the above-described range, a superior catalyst activity per unit mass and a desired charge-discharge capacity in accordance with the supporting amount can be obtained. When the mass ratio Fe/C in the composite electrode material according to this embodiment exceeds 1/0.01, the Fe₃O₄ particulates are easily agglomerated. Accordingly, a rate of utilization of the active material tends to be reduced. When the mass ratio is less than 1/100, the charge-discharge capacity tends to be insufficient. Incidentally, the supporting amount of the Fe₃O₄ particulates is obtained by atomic absorption measurement.

The method of producing the Fe₃O₄ particulates is not particularly limited. However, for obtaining uniform Fe₃O₄ particulates, a solution polymerization method in which an organic solvent containing iron complex compounds based on a method disclosed in Journal of American Chemical Society 126 (2004)273 is preferably adopted.

The method of producing the composite electrode material according to this embodiment will be explained below.

The method of producing the composite electrode material according to this embodiment includes a step of bringing a carbon base material into contact with an organic solution containing iron complex compounds under non-oxidizing atmosphere at a temperature of 100 to 400° C. to prepare a liquid substance containing iron oxide particles mainly containing Fe₃O₄, and a step of separating the liquid substance into a solid phase and a liquid phase and drying the solid phase to obtain a dried solid.

In the method of producing the composite electrode material according to this embodiment, the dried solid may be used as the composite electrode material. The dried solid may also be subjected to thermal treatment at a temperature of 300 to 1000° C. under non-oxidizing atmosphere. By the thermal treatment in the above temperature range, the electrode performance is improved.

When a surfactant is used in the above-mentioned steps, the surfactant absorbed into the Fe₃O₄ particulates can be removed by the thermal treatment.

Incidentally, the “non-oxidizing atmosphere” means atmosphere which does not substantially contain oxidizing substances such as oxygen. It may contain both of inactive atmosphere such as nitrogen, argon, and helium, and reductive atmosphere such as hydrogen. However, it is usually inactive atmosphere.

In the method of producing the composite electrode material according to this embodiment, the organic solution is a solution prepared by dissolving iron complex compound in an organic solvent. The organic solution can contain other organic compounds and the like.

It is required that the organic solvent can dissolve the iron complex compound. Examples of the organic solvent include benzyl ether, benzyl alcohol, ethylene glycol, propylene glycol, 2-methoxyethanol, phenol, cresol, diethylene glycol, triethylene glycol, 1,4-dioxane, furfural, cyclohexanone, butyl acetate, ethylene carbonate, propylene carbonate, formamide, N-methylformamide, N-methylacetamide, N,N-dimethyl acetamide, N-methyl-2-pyrrolidone, propionitrile, succinonitrile, benzonitrile, nitromethane, nitrobenzene, ethylenediamine, pyridine, piperidine, morpholine, dimethylsulfoxide, and sulfolane. These organic solvents each may be used singly, or two or more kinds of them may be used in combination.

An example of the iron complex compound, which can be used, include a chelate complex of Fe. Tris(2,4-pentadionato)iron(III) (hereinafter referred to as “Fe(acac)₃”) is preferable as the iron complex compound.

The concentration of the iron complex compound in the organic solvent is preferably 0.01 to 1 mol/L. When synthesis is conducted in this concentration range, Fe₃O₄ particulates having D₉₀ of 50 nm or less can be obtained relatively easily. Especially, when the concentration of the iron complex compound in the organic solution is 0.1 to 0.2 mol/L, Fe₃O₄ particulates having a particle size of 5 to 10 nm and a strong bonding force to be bonded to a carbon base material, which is highly dispersed, are formed. When the concentration of the iron complex compound is less than 0.1 mol/L, the bonding force for bonding the formed Fe₃O₄ particulates and the carbon base material tends to be reduced. When the concentration of the iron complex compound exceeds 0.2 mol/L, particles of the Fe₃O₄ particulates are easily grown.

In the organic solvent, the mass ratio of the iron complex compound to the carbon base material (where the iron complex compound is assumed to be 1) is usually from 1/0.01 to 1/100, preferably from 1/0.02 to 1/20. When the mass ratio is within the above range, Fe₃O₄ particulates having superior catalyst activity per unit mass and high dispersibility can be supported. Further, in the organic solvent, the mass ratio of Fe in the iron complex compound to C in the carbon base material is usually from 1/0.063 to 1/633, preferably from 1/0.126 to 1/126, more preferably from 1/0.2 to 1/10.

For improving the dispersibility of the generated Fe₃O₄ particulates, a dispersant such as saturated hydrocarbon diol having a carbon number of 2 to 20 such as 1,2-hexadecanediol may be added to the organic solvent as needed.

For stabilizing the iron complex compound and suppressing agglomeration of the generated Fe₃O₄ particulates, it is preferable that the organic solution contain a surfactant. Also, by changing a mixture ratio of the iron complex compound to the surfactant, a particle size of the particulates can be controlled.

Examples of the surfactant include oleic acid, oleylamine, didecyl dimethylammonium bromide, didecyldimethyl ammonium chloride, didodecyl dimethyl ammonium bromide (or chloride), cetyl trimethyl ammonium bromide (or chloride), and dodecyl trimethyl ammonium bromide (or chloride). These compounds each may be used singly, or two or more kinds of them may be used in combination. Especially, the oleic acid is favorably used because it maintains the generated Fe₃O₄ particulates to have a uniform particle size and stably protects them.

The concentration of the surfactant in the organic solvent is 0.0001 to 0.1 mol/L, preferably 0.001 to 0.01 mol/L. When the concentration of the surfactant is less than 0.0001 mol/L, the generated Fe₃O₄ particulates are unstable and easily broken in some cases. When the concentration exceeds 0.1 mol/L, particulates may not be generated or a metal raw material may not be reacted in some cases. By using the surfactant in the above-described range, Fe₃O₄ particulates having a target particle size (D₉₀: 50 nm or less) can be reproducibly formed.

The carbon base material described above in explaining the composite electrode material according to this embodiment can be used as the carbon base material here. Therefore, a detail thereof is already explained above, and an explanation thereof is omitted here.

Fibrous carbon may be favorably used as the carbon base material. Fibrous carbon having a hollow structure is more preferable for holding iron oxide particles inside. In the fibrous carbon, a wall surface has hydrophobicity and an iron complex compound is strongly absorbed. Therefore, in a drying step, it is assumed that the iron complex compound is not easily agglomerated and the Fe₃O₄ particulates having a small particle size are supported to be highly dispersed.

One example of specific procedures of the method of producing the composite electrode material according to this embodiment will be explained below.

Firstly, a prescribed amount of an organic solvent, a prescribed amount of an iron complex compound, and a surfactant or the like if necessary are put in a container such as a recovery flask, and the mixture is stirred by ultrasonic irradiation after container atmosphere is replaced with non-oxidizing gas such as argon and nitrogen, so that the iron complex compound is completely dissolved. Next, a prescribed amount of a carbon base material is added to the solution and the resultant solution is stirred until the carbon base material is sufficiently dispersed.

Subsequently, a prescribed amount of a dispersant such as 1,2-hexadecanediol is added. While the non-oxidizing gas is circulated within the container, a prescribed temperature in a temperature range of 100 to 400° C. is maintained using a temperature controller. The gas is refluxed at the prescribed temperature or above. Accordingly, a decomposition reaction of the iron complex compound progresses, so that Fe₃O₄ particulates are generated to obtain a liquid substance. The liquid substance contains the Fe₃O₄ particulates and the carbon base material in addition to the organic solvent. Then, the liquid substance is separated into a solid phase and a liquid phase and the solid phase is dried after the liquid substance is cooled to room temperature, so that a composite electrode material comprising a carbon base material supporting Fe₃O₄ particulates can be obtained.

A method for the solid-liquid separation of the liquid substance is not particularly limited, and any conventional solid-liquid separation method can be adopted. However, a centrifugal separation method is preferable when a synthesis amount is relatively small. A separation condition can be appropriately decided depending on an amount of a composite electrode material to be produced and a type of a carbon base material, and the like. More specifically, hexane or the like is added to the cooled solution and divided into glass tubes to conduct centrifugal separation (6000 rpm, approximately 10 minutes), so that a composite electrode material comprising a carbon base material supporting Fe₃O₄ particulates can be obtained.

The drying after the solid-liquid separation is usually conducted by heating, but blowing-drying or vacuum-drying can also be conducted. Further, non-oxidizing atmosphere such as nitrogen and argon is preferable as atmosphere for drying. When the drying is conducted by heating, the temperature is usually 50 to 150° C.

A negative electrode containing the composite electrode material according to this embodiment; and the metal-air battery including the negative electrode, a positive electrode and an electrolytic solution will be explained below.

The negative electrode according to this embodiment contains the composite electrode material according to this embodiment as an essential component in which a negative electrode mixture containing a bonding agent and a conductive agent if needed is adhered to a negative electrode current collector, i.e., in which a layer comprising the composite electrode material is formed on the current collector. The negative electrode according to this embodiment usually has a sheet-like shape. When the negative electrode has a sheet-like shape, its thickness is usually approximately from 5 to 500 μm.

The negative electrode mixture may contain a binder as needed. Thermoplastic resin may be used as the binder. Examples of the thermoplastic resin include polyvinylidene fluoride (PVdF), thermoplastic polyimide, carboxymethylcellulose, polyethylene, and polypropylene.

The negative electrode current collector may be Cu, Ni, or stainless steel. Cu is preferable for easily preparing a thin film. A method of supporting the negative electrode mixture on the negative electrode current collector may be a pressing and molding method or a method of processing the negative electrode mixture to a paste using a solvent or the like, applying it on the negative electrode current collector, and pressing it after drying it for bonding it by pressure.

A method of preparing the negative electrode may be a conventional method. Specifically, examples thereof include a method of applying a negative electrode mixture prepared by adding a solvent to the composite electrode material according to this embodiment to a negative electrode current collector using a doctor blade method or the like, or immersing the negative electrode current collector into the negative electrode mixture, and drying it, a method of pressing and drying a sheet by thermal treatment after the sheet obtained by adding a solvent to the composite electrode material according to this embodiment, kneading, molding, and drying is connected to a surface of a negative electrode current collector via a conductive adhesive agent or the like, and a method of forming a mixture of the composite electrode material according to this embodiment, a bonding agent, and a liquid lubricant agent on a surface of a negative electrode current collector and removing the liquid lubricant agent for subjecting the obtained sheet-like molded article to extension treatment in an uniaxial or multiaxial directions.

The metal-air battery according to this embodiment includes the negative electrode according to this embodiment, the positive electrode, and the electrolytic solution.

The positive electrode is composed of a positive electrode current collector and a positive electrode catalyst layer formed on the positive electrode current collector. Also, an oxygen diffusion membrane may be provided as described later to be laminated on the positive electrode.

It is required that the positive electrode current collector be a conductive material. For example, a metal such as nickel, chrome, iron, and titanium or an alloy may be used. Among them, nickel and stainless steel (iron-nickel-chrome alloy) are preferable. The shape of the positive electrode current collector is a mesh-like shape, a porous plate-like shape, or the like.

It is required that a positive electrode lead be a conductive material. For example, one or more metals selected from the group consisting of nickel, chrome, iron, and titanium or an alloy containing two or more metals selected from the group above may be used. Among them, nickel and stainless steel are preferable. The shape of the positive electrode lead is preferably like a plate, mesh, porous plate, metal sponge or the like.

The positive electrode catalyst layer includes a positive electrode catalyst as described below. Preferably, in addition to the positive electrode catalyst, the positive electrode catalyst layer contains a conductive agent and a bonding agent for bonding it to the positive electrode current collector.

It is required that the positive electrode catalyst be a material capable of reducing oxygen. Examples of the positive electrode catalyst include a non-oxide material such as a carbon base material such as activated carbon, platinum, and iridium; or an oxide material such as manganese oxide such as manganese dioxide, iridium oxide, iridium oxide containing one or more metals selected from the group consisting titanium, tantalum, niobium, tungsten and zirconium, and perovskite-like composite oxide indicated by ABO₃.

A preferable example of the positive electrode catalyst layer among them includes a positive electrode catalyst layer containing manganese dioxide or platinum. Another preferable example thereof includes a positive electrode catalyst layer containing the perovskite-like composite oxide indicated by ABO₃, which contains at least two elements selected from the group consisting of La, Sr and Ca on A site and contains at least one element selected from the group consisting of Mn, Fe, Cr, and Co on B site.

Especially, platinum is preferable because it has a high catalyst activity to reduction of oxygen. Also, the perovskite-like composite oxide is preferable because it has an oxygen storage/release capacity and can be used as a positive electrode catalyst layer for a secondary battery.

The conductive agent is not particularly limited as long as it is a material capable of improving the conductivity of the positive electrode catalyst layer. Specifically, examples thereof include a carbon base material such as acetylene black and ketjen black.

It is required that the bonding agent be not dissolved into the electrolytic solution to be used. Examples thereof include fluorine resin such as polytetrafluoroethylene (PTFE), tetrafluoroethylene-perfluoroalkyl vinylether copolymer, tetrafluoroethylene-hexafluoropropylene copolymer, tetrafluoroethylene-ethylene copolymer, polyvinylidene fluoride, polychlorotrifluoroethylene, and chlorotrifluoroethylene-ethylene copolymer.

It is required that the oxygen diffusion membrane be a membrane capable of favorably transmitting oxygen (air). Unwoven cloth or a porous membrane of resin such as polyolefin and fluorine resin may be used. Specifically, examples thereof include resin such as polyethylene, polypropylene, polytetrafluoroethylene, and polyvinylidene fluoride. The oxygen diffusion membrane is provided to be laminated on the positive electrode. Oxygen (air) is supplied to the positive electrode via the oxygen diffusion membrane.

A separator is not particularly limited as long as it is an insulating material capable of moving electrolyte. For example, unwoven cloth or a porous membrane of resin such as polyolefin and fluorine resin may be used. Specifically, examples of the resin include polyethylene, polypropylene, polytetrafluoroethylene, or polyvinylidene fluoride. When the electrolyte is an aqueous solution, examples of the resin include polyethylene, polypropylene, polytetrafluoroethylene, or polyvinylidene fluoride subjected to hydrophilization treatment.

A laminated body is formed by laminating the above-described negative electrode, separator, positive electrode, oxygen diffusion membrane in this order.

The electrolyte is usually dissolved in an aqueous solvent and a nonaqueous solvent so as to be used as an electrolytic solution, and is in contact with the negative electrode, separator, and positive electrode.

When the aqueous solvent is used, it is preferable that the electrolytic solution be an aqueous solution in which NaOH, KOH, or NH₄Cl is dissolved as electrolyte. At this time, the concentration of NaOH, KOH, or NH₄Cl in the aqueous solution is preferably 1 to 99 mass %, more preferably 3 to 60 mass %, further preferably 5 to 40 mass %.

In the metal-air battery according to this embodiment, it is preferable that the electrolytic solution contain a hydrogen generation inhibitor. By containing the hydrogen generation inhibitor in the electrolytic solution, a hydrogen-generating reaction as a side reaction is suppressed. As a result, a charge-discharge capacity of the battery can be increased. An example of the hydrogen generation inhibitor includes metal sulfides. Especially, alkali metal sulfide is preferable among them. K₂S is preferable among the alkali metal sulfides. Incidentally, the concentration of the hydrogen generation inhibitor in the electrolytic solution can be appropriately decided in a range where a battery reaction is not impaired.

### EXAMPLES

The present invention will be explained in detail below with reference to Example. However, the present invention is not limited to the Examples as long as they fall within the spirit and scope of the present invention.

In the Examples, a reagent and raw material as follows were used.

### [Reagent]

Tris(2,4-pentadionato)iron(III) (Fe(acac)₃ for short): Sigma-Aldrich Co., LLC.

oleylamine: Sigma-Aldrich Co., LLC.

dibenzyl ether: Wako Pure Chemical Industries, Ltd.

1,2-hexadecanediol: Sigma-Aldrich Co., LLC.

### [Carbon Base Material]

Fibrous carbons as follows were used as a carbon base material.

TCNF (Tubular Carbon Nano-Fiber): hollow fibrous carbon

G-TCNF (Graphitized-TCNF): hollow fibrous carbon

VGCF (Vapor-Grown Carbon Fiber): non-hollow fibrous carbon (manufactured by Showa Denko K.K. (trade name), a diameter of 150 nm, a fiber length of 10 to 20 μm, an aspect ratio of 10 to 500)

TCNF and G-TCNF were synthesized by the following procedures.

(1) Synthesis of TCNF

The synthesis of TCNF was conducted in accordance with a method disclosed in JP 2003-342839 A and JP 2003-342840 A.

Firstly, carbon black carriers (“MA-3050B (trade name)” manufactured by MITSUBISHI GAS CHEMICAL COMPANY, INC.; a BET ratio surface area of 43 m²/g, a particle size of 40 nm) supporting 5 mass % of Fe—Ni (Fe:Ni=2:8 (mass ratio)) were bonded by a binder of phenolic resin and granulated, so that a bed material for a CNT production catalyst was obtained.

Next, the bed material for the CNT production catalyst was brought into contact with mixed gas of H₂/He (20/80 (volume ratio)) in a fluid bed reaction container at 630° C. for 7 hours, and the mixture was subjected to catalyst activation treatment.

Subsequently, mixed gas of C₂H₄/H₂ (80/20 (volume ratio)) as gas for generating carbon was supplied into the fluid bed reaction container to have a flow rate enough to enable the bed material for the CNT production catalyst to be fluidized sufficiently and maintained at 480° C. for one hour so as to produce fibrous carbon (TCNF).

Then, the binder was thermally decomposed by rising temperature to 630° C. in atmosphere of H₂/He (20/80 (volume ratio)) and a catalyst was microparticulated to be scattered and collected by a collecting means so as to obtain TCNF.

(2) Synthesis of G-TCNF

TCNF was subjected to thermal treatment at 2800° C. for one hour in Ar gas atmosphere so as to obtain G-TCNF.

Valuation methods according to the Examples were as follows.

(1) X-Ray Diffraction (XRD) Measurement

The XRD measurement was conducted to identify a composite electrode material according to the Examples under conditions as follows.

Measurement device: RINT2000 (manufactured by Rigaku Corporation)

Radiation source: CuKα

Tube voltage: 50 kV

Tube current: 300 mA

(2) Transmission Electron Microscope (TEM) Observation

The configuration and particle size of the composite electrode material according to the Examples were observed by TEM. A sample to be observed was prepared by dispersing the synthesized composite electrode material in hexane and dropping it on a Cu grid.

Measurement device: JKM-2100F manufactured by JEOL Ltd.

(3) Fourier Transform Infrared Spectroscopy (FT-IR) Measurement

The FT-IR measurement was conducted to check whether an organic solvent and a surfactant remain in the composite electrode material according to the Examples.

Measurement device: FTIR-4000 (JASCO Corporation)

Measurement range: 4000 to 600 cm⁻¹

(4) Atomic Absorption Measurement

The atomic absorption measurement of the synthesized sample was conducted to obtain a Fe amount (in terms of mass) in the composite electrode material according to the Examples.

Measurement device: polarized Zeeman atomic absorption spectrophotometer Z-5310 (Hitachi High-Technologies Corporation)

Standard solution for a standard curve: Fe standard solution (Wako Pure Chemical Industries, Ltd.)

(Composite Electrode Material 1)

Firstly, 3 mmol of Fe(acac)₃ was added into a mixed solution of oleic acid (3 mmol), oleylamine (6 mmol), and dibenzyl ether (10 ml) and the resultant solution was dissolved by ultrasonic vibration so as to obtain 0.2 mol/L of a Fe(acac)₃ solution. Then, TCNF was added to the solution so that Fe/C may equal 3/8 (mass ratio) and the resultant mixture was stirred by ultrasonic vibration for 10 minutes or longer so as to uniformly disperse TCNF in the solution to obtain a slurry. After 1,2-hexadecanediol (5 mmol) was added into the slurry containing TCNF, the resultant was heated at a rate of temperature rise of 10° C./min and stirred under Ar atmosphere, held at 200° C. for two hours, and then refluxed at 300° C. for one hour to obtain a liquid substance. After the liquid substance was cooled, hexane was added thereto, and then the liquid substance was separated into a solid phase and a liquid phase by centrifugal separation at 12000 rpm for 10 minutes at several times. After the obtained solid phase was dried at 60° C. for three hours, iron oxide particles which were not supported by the carbon base material were removed so as to obtain the composite electrode material 1 in powder form.

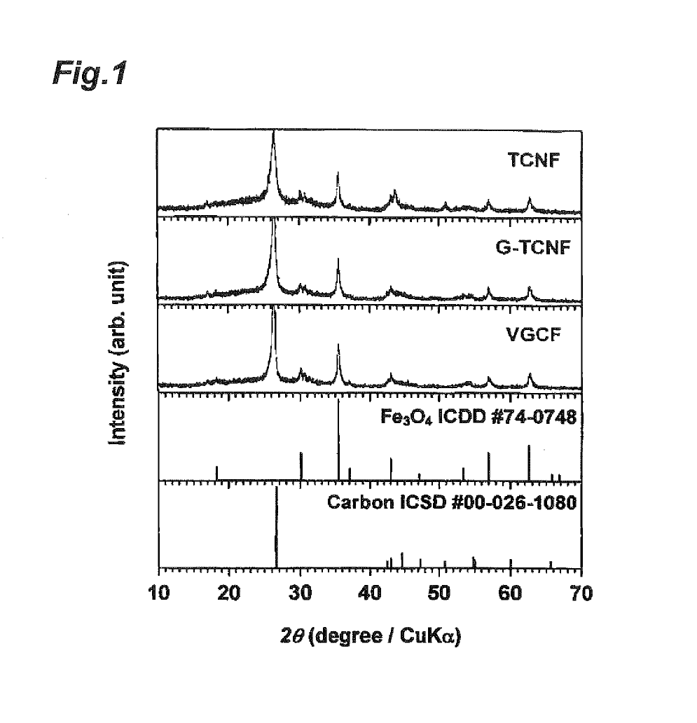

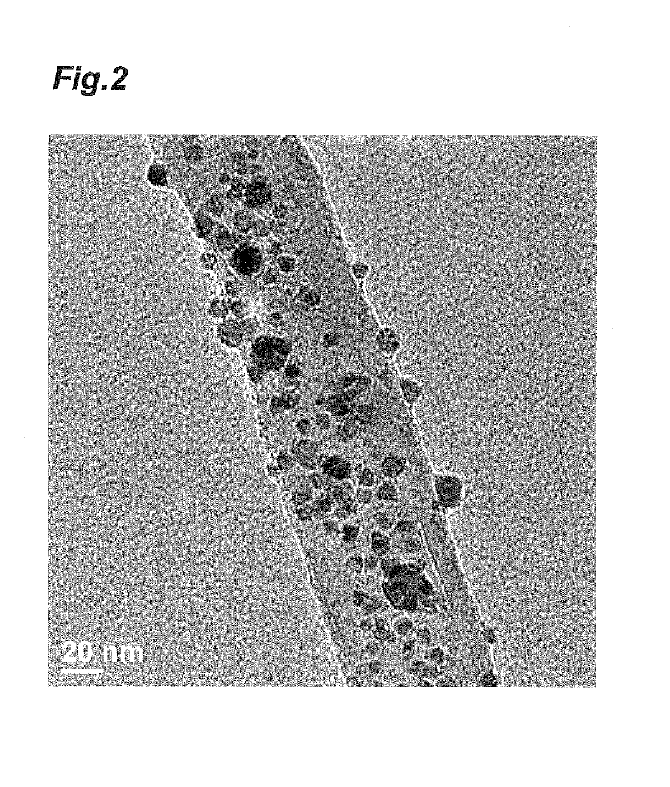

FIG. 1 shows an XRD pattern and FIG. 2 shows a TEM image as an evaluation of the obtained composite electrode material. Also, Table 1 collectively shows production conditions and a Fe/C ratio of the obtained composite electrode material. Incidentally, 3/8 which is a mass ratio of Fe/C (in the liquid substance) as shown in Table 1 can be converted to 1/0.42 which is a mass ratio of Fe(acac)₃ to the carbon base material using 353.17 which is a molar weight of Fe(acac)₃ and 55.85 which is an atomic weight of Fe.

(Composite Electrode Material 2)

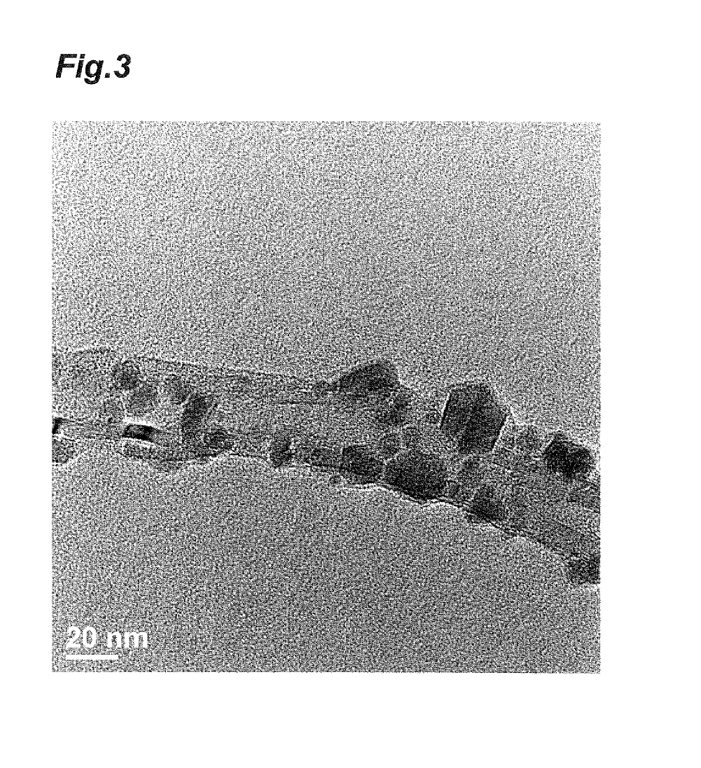

A composite electrode material 2 was obtained in the same manner as the composite electrode material 1 except that G-TCNF was used instead of TCNF. FIG. 1 shows an XRD pattern and FIG. 3 shows a TEM image as an evaluation of the obtained composite electrode material. Also, Table 1 collectively shows production conditions and a Fe/C ratio of the obtained composite electrode material.

(Composite Electrode Material 3)

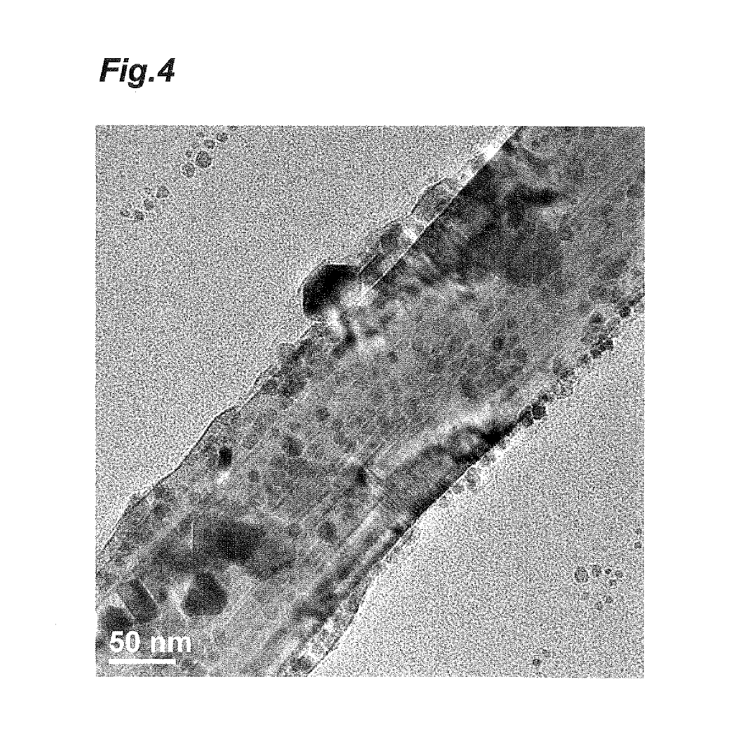

A composite electrode material 3 was obtained in the same mariner as the composite electrode material 1 except that VGCF was used instead of TCNF. FIG. 1 shows an XRD pattern and FIG. 4 shows a TEM image as an evaluation of the obtained composite electrode material. Also, Table 1 collectively shows production conditions and a Fe/C ratio of the obtained composite electrode material.

(Composite Electrode Material 4)

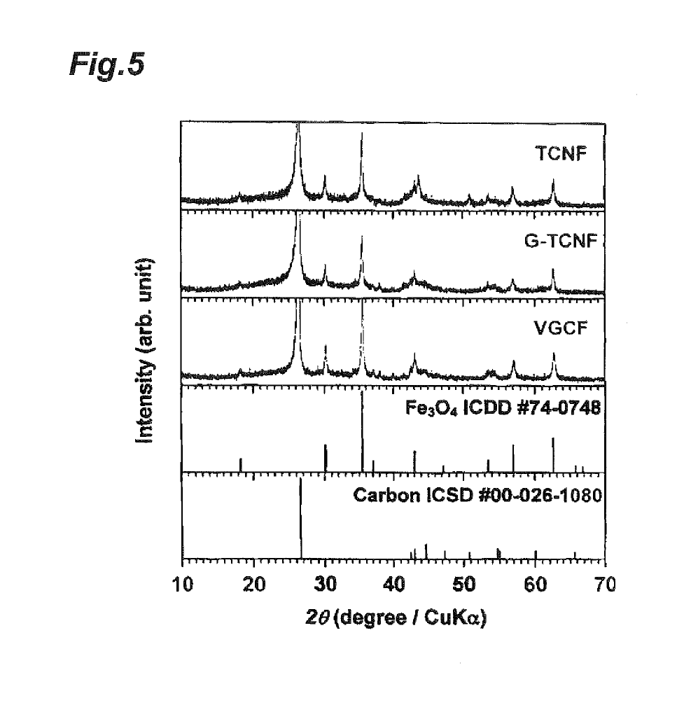

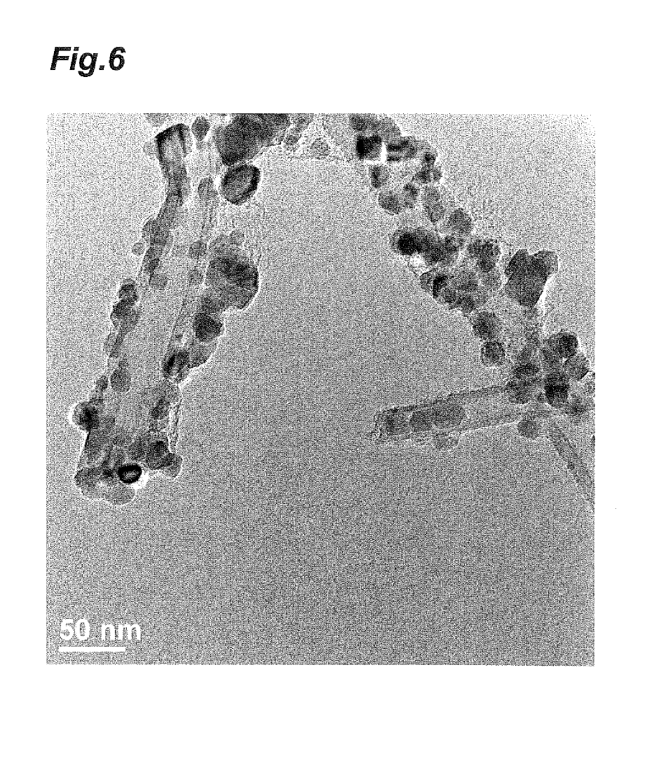

A composite electrode material 4 was obtained by subjecting the composite electrode material 1 to calcining treatment (thermal treatment) at 500° C. for three hours in Ar. FIG. 5 shows an XRD pattern and FIG. 6 shows a TEM image as an evaluation of the obtained composite electrode material. Also, Table 1 collectively shows production conditions and a Fe/C ratio of the obtained composite electrode material.

(Composite Electrode Material 5)

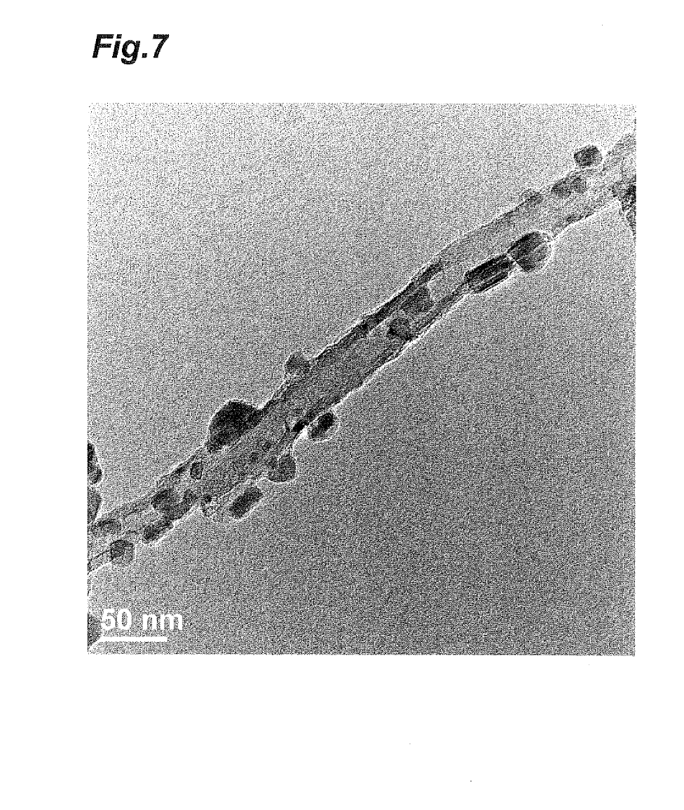

A composite electrode material 5 was obtained by subjecting the composite electrode material 2 to calcining treatment (thermal treatment) at 500° C. for three hours in Ar. FIG. 5 shows an XRD pattern and FIG. 7 shows a TEM image as an evaluation of the obtained composite electrode material. Also, Table 1 collectively shows production conditions and a Fe/C ratio of the obtained composite electrode material.

(Composite Electrode Material 6)

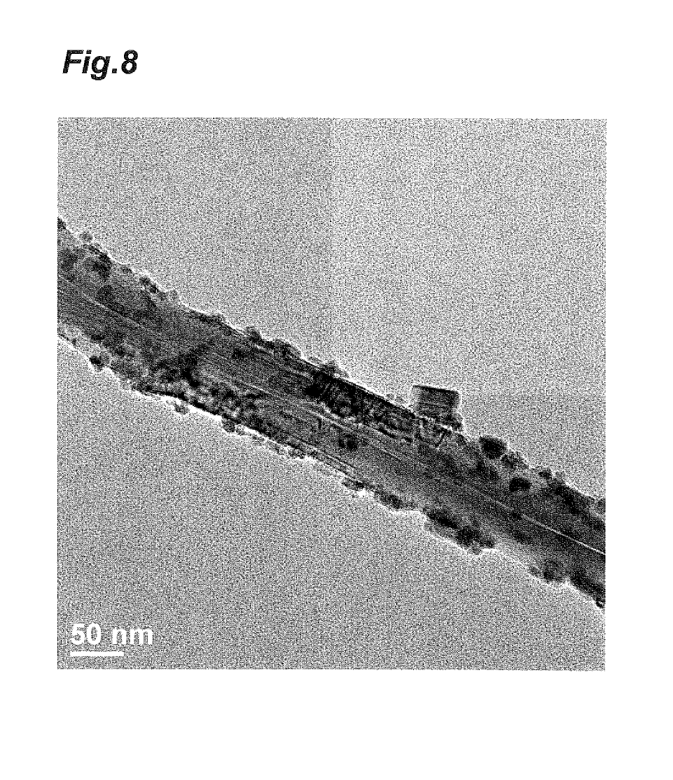

A composite electrode material 6 was obtained by subjecting the composite electrode material 3 to calcining treatment (thermal treatment) at 500° C. for three hours in Ar. FIG. 5 shows an XRD pattern and FIG. 8 shows a TEM image as an evaluation of the obtained composite electrode material. Also, Table 1 collectively shows production conditions and a Fe/C ratio of the obtained composite electrode material.

(Composite Electrode Material 7)

Firstly, 1.54 mmol of Fe(acac)₃ was added into a mixed solution of oleic acid (3 mmol), oleylamine (6 mmol), and dibenzyl ether (10 ml) and the resultant solution was dissolved by ultrasonic vibration so as to obtain 0.1 mol/L of a Fe(acac)₃ solution.

Then, TCNF was added to the solution so that Fe/C may equal 3/16 (mass ratio) and the resultant solution was stirred by ultrasonic vibration for 10 minutes or longer so as to uniformly disperse TCNF in the solution to obtain a slurry.

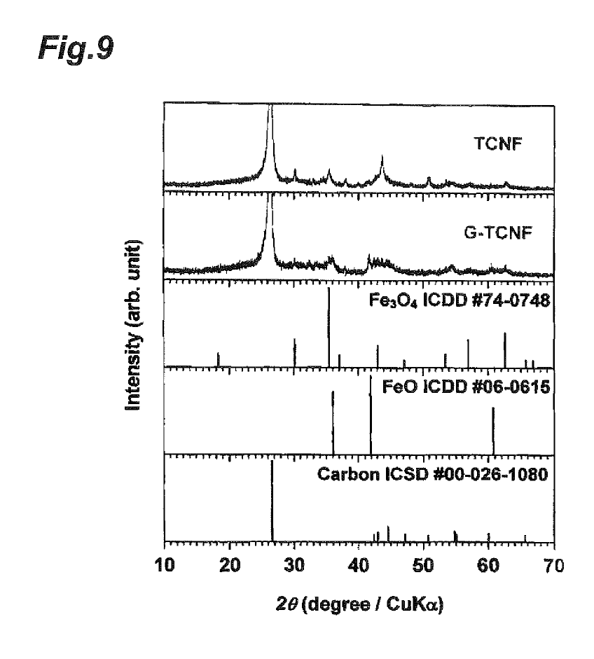

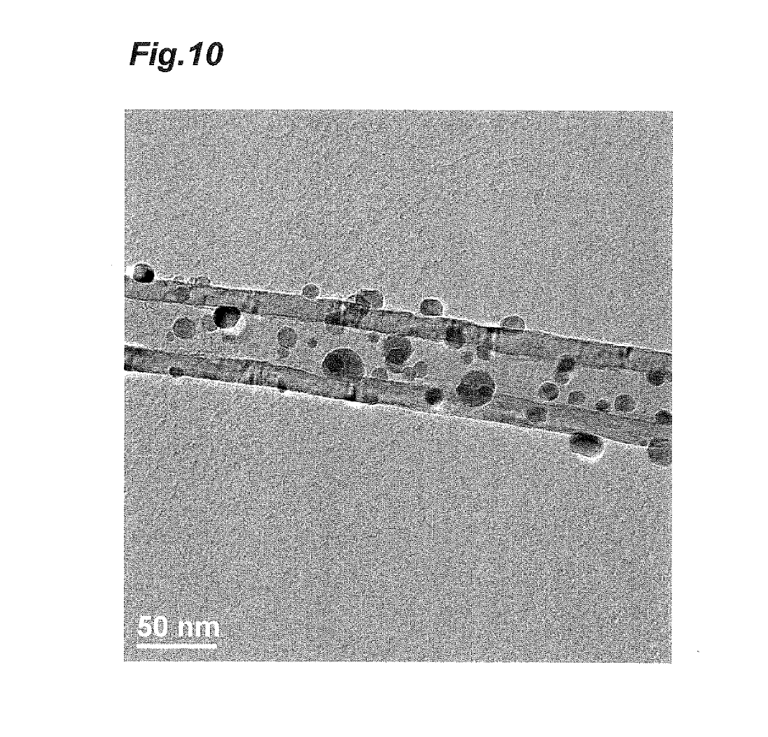

After 1,2-hexadecanediol (5 mmol) was added into the slurry containing TCNF, the resultant was heated at a rate of temperature rise of 10° C./min and stirred under Ar atmosphere, held at 200° C. for two hours, and then refluxed at 300° C. for one hour to obtain a liquid substance. After the liquid substance was cooled, hexane was added thereto, and then the liquid substance was separated into a solid phase and a liquid phase by centrifugal separation at 12000 rpm for 10 minutes at several times. After the obtained solid phase was dried at 60° C. for three hours, iron oxide particles which were not supported by the carbon base material were removed so as to obtain a sample in powder form. Subsequently, the sample was subjected to calcining treatment (thermal treatment) at 500° C. for three hours in Ar, obtaining a composite electrode material 7 thereby. FIG. 9 shows an XRD pattern and FIG. 10 shows a TEM image as an evaluation of the obtained composite electrode material. Also, Table 1 collectively shows production conditions and a Fe/C ratio of the obtained composite electrode material. Incidentally, 3/16 which is a mass ratio of Fe/C (in the liquid substance) as shown in Table 1 can be converted to 1/0.84 which is a mass ratio of Fe(acac)₃ to the carbon base material using 353.17 which is a molar weight of Fe(acac)₃ and 55.85 which is an atomic weight of Fe.

(Composite Electrode Material 8)

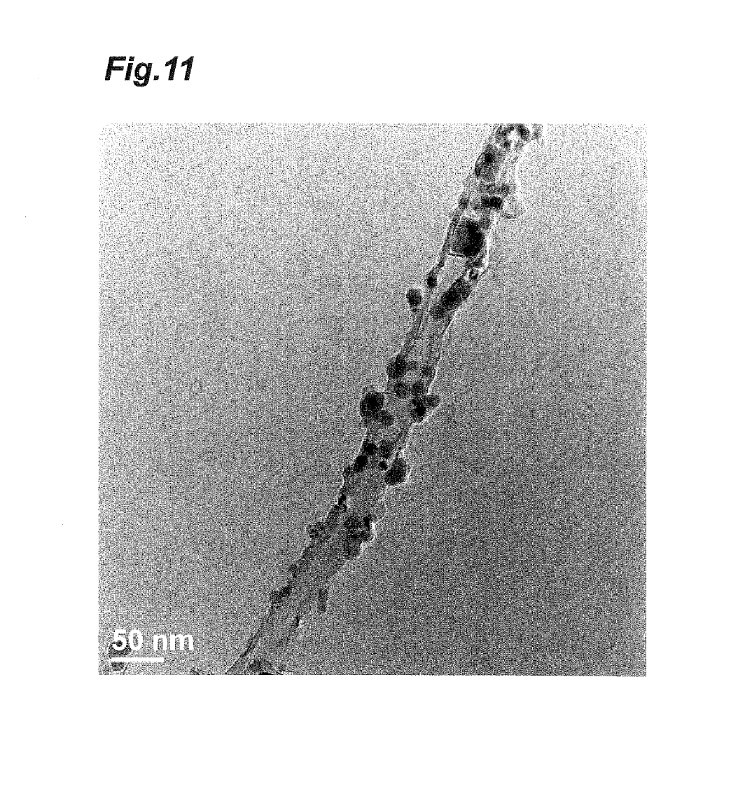

A composite electrode material 8 was obtained in the same manner as the composite electrode material 7 except that G-TCNF was used instead of TCNF. FIG. 9 shows an XRD pattern and FIG. 11 shows a TEM image as an evaluation of the obtained composite electrode material. Also, Table 1 collectively shows production conditions and a Fe/C ratio of the obtained composite electrode material.

TABLE 1

| | | | | | Fe/C |
|---|---|---|---|---|---|
| | | | | | (Measurement |
| | Fe(acac)₃ | Fe/C | | | value by atomic |
| | (Concentration | (In the liquid | | | absorption |
| | in the solution) | substance) | Type of | | analysis) |
| | [mol/L] | [mass ratio] | CNF | Calcining | [mass ratio] |
| Composite electrode | 0.2 | 3/8 | TCNF | None | — |
| material 1 | | | | | |
| Composite electrode | 0.2 | 3/8 | G-TCNF | None | — |
| material 2 | | | | | |
| Composite electrode | 0.2 | 3/8 | VGCF | None | — |
| material 3 | | | | | |
| Composite electrode | 0.2 | 3/8 | TCNF | Ar, 500° C. | 1/6 |
| material 4 | | | | | |
| Composite electrode | 0.2 | 3/8 | G-TCNF | Ar, 500° C. | 1/7 |
| material 5 | | | | | |
| Composite electrode | 0.2 | 3/8 | VGCF | Ar, 500° C. | 1/7 |
| material 6 | | | | | |
| Composite electrode | 0.1 | 3/16 | TCNF | Ar, 500° C. | 1/29 |
| material 7 | | | | | |
| Composite electrode | 0.1 | 3/16 | G-TCNF | Ar, 500° C. | 1/17 |
| material 8 | | | | | |

“Uncalcined Sample: Composite Electrode Materials 1 to 3”

As a result of XRD of the composite electrode materials 1 to 3 as shown in FIG. 1, along with a signal of carbon derived from each carbon base material, a signal of Fe₃O₄ was observed. Signals of iron oxides other than Fe₃O₄ were not observed.

In the TEM images as shown in FIGS. 2 to 4, it was confirmed that iron oxide particulates of 50 nm or less were supported on a wall surface of each fibrous carbon. It was also confirmed that iron oxide particulates were formed inside in the composite electrode materials 1 and 2 using hollow fibrous carbon. Incidentally, it was found that D₉₀ in the composite electrode materials 1 to 3 was 50 inn or less.

“Ar Atmosphere Thermal Treatment Sample: Composite Electrode Materials 4 to 8”

As a result of XRD of the composite electrode materials 4 to 6 as shown in FIG. 5, along with a signal of carbon derived from each carbon base material, a signal of Fe₃O₄ was observed similarly to the composite electrode materials 1 to 3 before being subjected to thermal treatment. Signals of iron oxides other than Fe₃O₄ were not observed. Also, a signal derived from the organic solvent or oleic acid of the surfactant was not observed in FT-IR. Accordingly, it was confirmed that these organic components were almost removed or carbonized by Ar thermal treatment.

As shown in the TEM images shown in FIGS. 6 to 8, 90% or more of iron oxide particulates supported on the wall surface of each fibrous carbon is 50 nm or less although particles were grown a little as compared to the samples before being subjected to thermal treatment (the composite electrode materials 1 to 3). It was also confirmed that iron oxide particulates were formed inside in the composite electrode materials 4 and 5. Further, it was found that D₉₀ in the composite electrode materials 4 to 6 was 50 nm or less.

As a result of XRD of the composite electrode materials 7 and 8 as shown in FIG. 9, in addition to a signal of carbon derived from each carbon base material, not only a signal of Fe₃O₄ as iron oxide but also a signal of FeO like a trace were observed. Also, a signal derived from the organic solvent or oleic acid of the surfactant was not observed in FT-IR. Accordingly, it was confirmed that these organic components were almost removed or carbonized by Ar thermal treatment.

As obvious from FIGS. 10 and 11, a particle size of the iron oxide particulates in the composite electrode materials 7 and 8 synthesized from 0.1 mmol/L of a Fe(acac)₃ solution is generally smaller than a particle size of the iron oxide particulates in the composite electrode materials 4 to 6 synthesized from 0.2 mol/L of a Fe(acac)₃ solution. Especially, in the composite electrode material 7 using TCNF as the carbon base material, the dispersibility of the iron oxide particles was high. It was hardly observed that the particles were adjacent to each other.

(Battery Evaluation)

An electrode was prepared by a method as described below using the composite electrode materials 4 to 8 to evaluate a negative electrode in a metal-air battery, and a three-electrode type cell was prepared using the electrode as a working electrode. Then, a charge-discharge test was conducted.

(i) Structure of Electrochemical Cell

The three-electrode type cell was used for electrochemical measurement. A working electrode (corresponding to the negative electrode in the battery according to the present invention) was prepared as described below.

Firstly, a suspension (PTFE:water=60:40 (mass ratio)) of polytetrafluoroethylene (PTFE, DUPONT-MITSUI POLYCHEMICALS CO., LTD) as a bonding material was added to a synthesized composite electrode material such that a mass ratio of the composite electrode material and PTFE was 90:10. After an appropriate amount of hexane was added, this solution was stirred by a stirrer until being evaporated so as to obtain a mixture. Next, this mixture was molded into a sheet-like shape using an agate mortar and the molded product was punched into φ10 mm using a cork borer so as to obtain a pellet electrode. The pellet electrode was sandwiched by SUS304 mesh (100 mesh, The Nilaco Corporation) of φ15 mm as a power collector and was pressed by a hydraulic pressing machine. Further, the vicinity of the mesh was spot-welded and a SUS304 line (φ10 mm, The Nilaco Corporation) was welded to a portion composed of only meshes to serve as a working electrode.

A platinum mesh (100 mesh, The Nilaco Corporation) was used as a counter electrode, and an Hg/HgO electrode (Eco Chemic B.V.) was used as a reference electrode.

The following three types of electrolytic solutions were used. To remove the effect of dissolved oxygen, each electrolytic solution was used after being bubbled by nitrogen gas in advance for 30 minutes.

Electrolytic solution 1: 8 mol/L of a KOH solution (pH: 15)

Electrolytic solution 2: 8 mol/L of a KOH solution containing K₂S (K₂S concentration: 0.01 mol/L)

Electrolytic solution 3: 8 mol/L of a KOH solution containing K₂S (K₂S concentration: 0.015 mol/L)

(ii) Charge-Discharge Measurement

The charge-discharge measurement was conducted by using a BTS2004H charge-discharge test apparatus (NAGANO Co., Ltd.).

After a cell was prepared and left for 24 hours while a circuit was opened for sufficiently transfusing the electrolytic solution into the electrode, the measurement was conducted under the conditions as described below.

Current Density

Charge: 0.5 mA/cm², −1.15 V (vs. Hg/HgO) constant-voltage charge (time was regulated by calculation of a coulombic amount)

Discharge: 0.2 mA/cm², −0.1V (vs. Hg/HgO) cut

* Here, V (vs. Hg/HgO) denotes a potential when Hg/HgO was used as the reference electrode.
Measurement temperature: 25° C.
Quiescent time: one hour
Measurement order: start from charging (a direction where a potential is lowered: reductive reaction of iron)
Measurement atmosphere: under nitrogen atmosphere

An electrical capacity of the electrode is indicated as a capacity per 1 g of Fe₃O₄ when all Fe elements contained in the electrode were Fe₃O₄. The amount of Fe₃O₄ (mass) was calculated by converting an Fe amount (mass) contained in the composite electrode material obtained by the atomic absorption measurement into an Fe₃O₄ amount.

(Charge-Discharge Test 1)

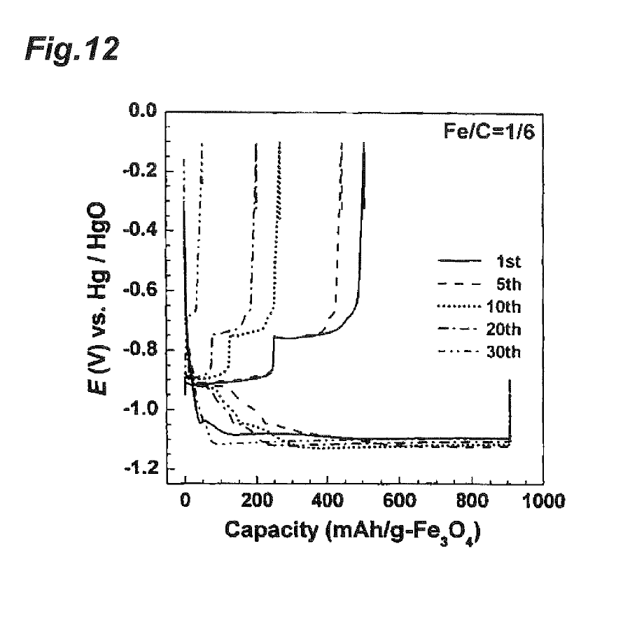

As a charge-discharge test 1, a charge-discharge test was conducted using an electrode of the composite electrode material 4 using the carbon base material TCNF. FIG. 12 shows its results. As an electrolytic solution, the electrolytic solution 1 which does not contain K₂S was used.

An initial discharge capacity in the charge-discharge test 1 was 505 mAh/g, and showed favorable cycle characteristics in first five cycles. In subsequent cycles, the discharge capacity was remarkably deteriorated and a capacity retention rate after 30 cycles was 10%.

The discharge capacity in the first five cycles was increased possibly because a conductive path was ensured by bonding the iron oxide particulates and the carbon base material (TCNF) in hetero and thus the conductivity of the electrode was improved. The discharge capacity after the five and subsequent cycles was remarkably reduced possibly because the iron oxide particulates were detached from the surface of the carbon base material (TCNF) by the hydrogen generation reaction occurred during charging, for example.

(Charge-Discharge Test 2)

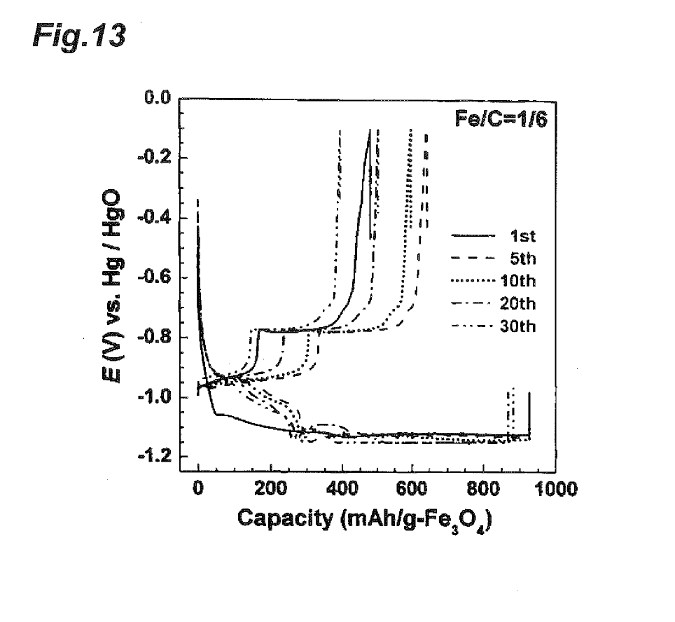

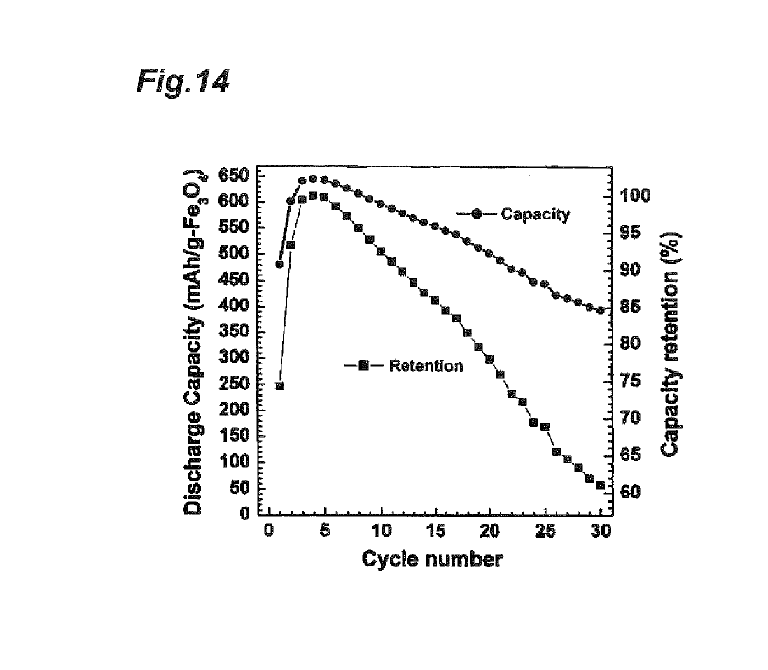

As a charge-discharge test 2, a charge-discharge test was conducted in the same manner as the charge-discharge test 1 except that the electrolytic solution 2 containing K₂S was used instead of the electrolytic solution 1. FIG. 13 shows its results. Also, FIG. 14 shows cycle characteristics in the charge-discharge test 2. Further, results of the cycle characteristics are collectively shown in Table 2.

An initial discharge capacity in the charge-discharge test 2 was 480 mAh/g. In four cycles, the discharge capacity became the maximum discharge capacity of 645 mAh/g. The capacity retention rate after 30 cycles was 61%.

Accordingly, it was found that the capacity retention rate was increased by adding K₂S as a hydrogen generation inhibitor. This is thought to be due to the fact that the effect of the electron conductivity improved by compounding and the reversibility improvement of the reaction by microparticulation was prominently manifested.

(Charge-Discharge Test 3)

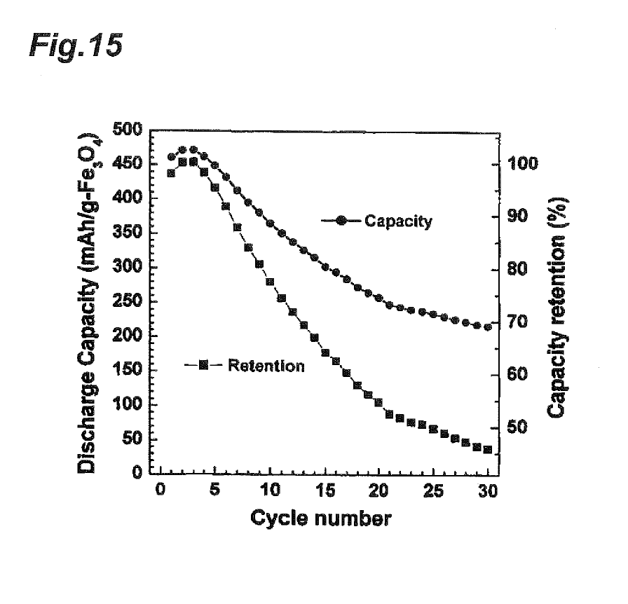

As a charge-discharge test 3, a charge-discharge test was conducted using an electrode of the composite electrode material 5 using the carbon base material G-TCNF. FIG. 15 shows its cycle characteristics. Further, results of the cycle characteristics are collectively shown in Table 2. As an electrolytic solution, the electrolytic solution 2 containing K₂S was used.

In the charge-discharge test 3, a potential flat portion was observed as when the electrode of the composite electrode material 4 using TCNF was used during charging. An initial discharge capacity in the charge-discharge test 3 was 460 mAh/g. In three cycles, the discharge capacity became the maximum discharge capacity of 470 mAh/g. The capacity retention rate after 30 cycles was 46%.

(Charge-Discharge Test 4)

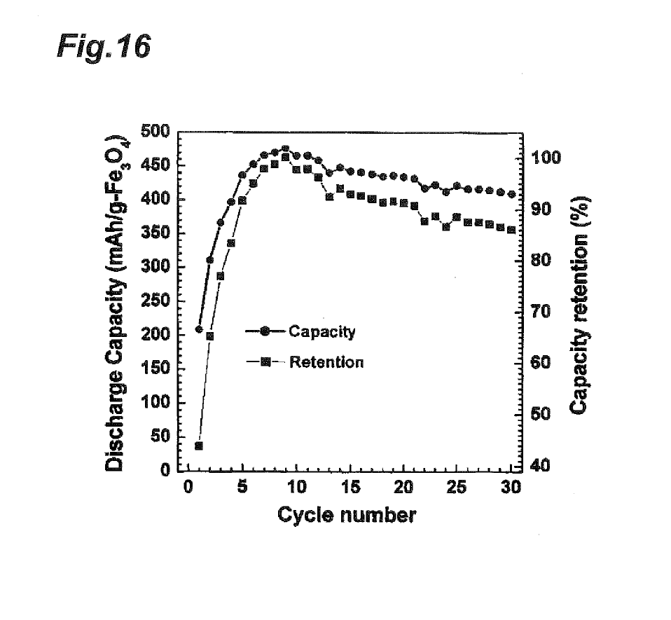

As a charge-discharge test 4, a charge-discharge test was conducted using an electrode of the composite electrode material 6 using the carbon base material VGCF. FIG. 16 shows its cycle characteristics. Also, results of the cycle characteristics are collectively shown in Table 2. As an electrolytic solution, the electrolytic solution 3 containing K₂S was used.

In the charge-discharge test 4, a potential flat portion was observed as when the electrode of the composite electrode material 4 using TCNF was used during charging. An initial discharge capacity in the charge-discharge test 4 was 210 mAh/g. In nine cycles, the discharge capacity became the maximum discharge capacity of 475 mAh/g. The capacity retention rate after 30 cycles was 86%.

(Charge-Discharge Test 5)

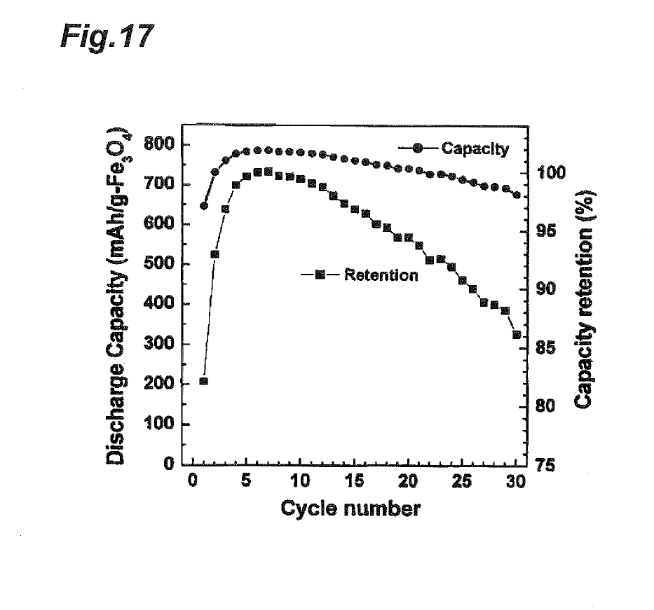

As a charge-discharge test 5, a charge-discharge test was conducted using an electrode of the composite electrode material 7 using the carbon base material TCNF. FIG. 17 shows its cycle characteristics. Also, results of the cycle characteristics are collectively shown in Table 2. As an electrolytic solution, the electrolytic solution 2 containing K₂S was used.

In the charge-discharge test 5, a potential flat portion was observed as when the electrode of the composite electrode material 4 was used. An initial discharge capacity in the charge-discharge test 5 was 645 mAh/g. In seven cycles, the discharge capacity became the maximum discharge capacity of 790 mAh/g. The capacity retention rate after 30 cycles was 86%.

(Charge-Discharge Test 6)

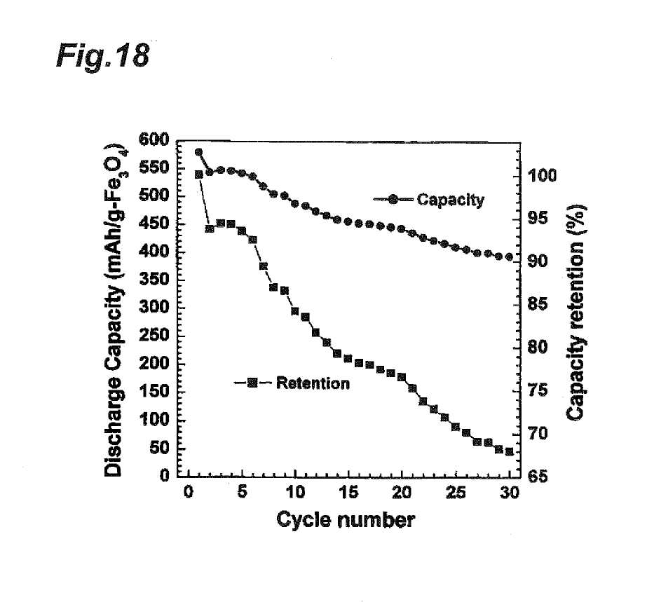

As a charge-discharge test 6, a charge-discharge test was conducted using an electrode of the composite electrode material 8 using the carbon base material G-TCNF. FIG. 18 shows its cycle characteristics. Also, results of the cycle characteristics are collectively shown in Table 2. As an electrolytic solution, the electrolytic solution 2 containing K₂S was used.

In the charge-discharge test 6, a potential flat portion was observed as when the electrode of the composite electrode material 7 was used. An initial discharge capacity in the charge-discharge test 6 was 580 mAh/g, which was the maximum discharge capacity. A capacity retention rate after 30 cycles was 68%.

TABLE 2

| | | Initial | Maximum | Capacity |
|---|---|---|---|---|
| | Composite | discharge | discharge | retention rate |
| | electrode | capacity | capacity | (in the 30th |
| | material | [mAh/g] | [mAh/g] | cycles) [%] |
| Charge- | Composite | 480 | 645 | 61 |
| discharge | electrode | | | |
| test 2 | material 4 | | | |
| Charge- | Composite | 460 | 470 | 46 |
| discharge | electrode | | | |
| test 3 | material 5 | | | |
| Charge- | Composite | 210 | 475 | 86 |
| discharge | electrode | | | |
| test 4 | material 6 | | | |
| Charge- | Composite | 645 | 790 | 86 |
| discharge | electrode | | | |
| test 5 | material 7 | | | |
| Charge- | Composite | 580 | 580 | 68 |
| discharge | electrode | | | |
| test 6 | material 8 | | | |

### INDUSTRIAL APPLICABILITY

According to the present invention, an electrode material which can achieve a high energy density can be obtained. An air battery using the electrode material can be favorably used for electric vehicles, and thus the present invention is extremely useful industrially.

What is claimed is:

1. A composite electrode material comprising a carbon base material and iron oxide particles mainly containing Fe₃O₄ and being supported on the carbon base material, the particles having a D₉₀ of 50 nm or less.

2. The composite electrode material according to claim 1, wherein the composite electrode material has an Fe/C mass ratio of from 1/0.01 to 1/100.

3. The composite electrode material according to claim 1, wherein the carbon base material is fibrous carbon.

4. The composite electrode material according to claim 3, wherein the fibrous carbon has a hollow structure.

5. A negative electrode for a metal-air battery, the negative electrode containing the composite electrode material according to claim 1.

6. A metal-air battery containing the negative electrode for the metal-air battery according to claim 5, a positive electrode and an electrolytic solution.

7. The metal-air battery according to claim 6, wherein the electrolytic solution contains a hydrogen generation inhibitor.

8. A method of producing a composite electrode material, comprising the steps of:
bringing a carbon base material into contact with an organic solution containing an iron complex compound at a temperature of 100 to 400° C. under non-oxidizing atmosphere, thereby forming a liquid substance containing iron oxide particles mainly containing Fe₃O₄; and
separating the liquid substance into a solid phase and a liquid phase and drying the solid phase to obtain a dried solid.

9. The method according to claim 8 further comprising a step of subjecting the dried solid to thermal treatment at a temperature of 300 to 1000° C. under non-oxidizing atmosphere.

10. The method according to claim 8, wherein the organic solution has a mass ratio of the iron complex compound to the carbon base material of from 1/0.01 to 1/10.

11. The method according to claim 8, wherein the iron complex compound is tris(2,4-pentadionato)iron(III).

12. The method according to claim 8, wherein the concentration of the iron complex compound in the organic solution is 0.01 to 1 mol/L.

13. The method according to claim 8, wherein the concentration of the iron complex compound in the organic solution is 0.1 to 0.2 mol/L.

14. The method according to claim 8, wherein the organic solution contains a surfactant.

15. The method according to claim 14, wherein the surfactant is oleic acid.

16. The method according to claim 8, wherein the carbon base material is fibrous carbon.

17. The method according to claim 16, wherein the fibrous carbon has a hollow structure.
